(19) United States
(12) Patent Application Publication
(10) Pub. No.: US 2020/0136440 A1
(43) Pub. Date: Apr. 30, 2020

(54) STATOR CORE COMPRISING COBALT CARBIDE AND METHOD OF MAKING THE SAME

(71) Applicant: Hamilton Sundstrand Corporation, Charlotte, NC (US)

(72) Inventors: Zachary Cohen, West Hartford, CT (US); Tod Policandriotes, Suffield, CT (US)

(21) Appl. No.: 16/176,706

(22) Filed: Oct. 31, 2018

(51) Int. Cl. H02K 1/02; H02K 1/16; H02K 11/01; H02K 15/02

(52) U.S. Cl. CPC H02K 1/02; H02K 15/024; H02K 11/01; H02K 1/16

(57) ABSTRACT

Disclosed is an electric machine, comprising: a rotor; and a stator core radially outward from the rotor, the stator core being stationary relative to the rotor during operation; wherein the stator core comprises: carbon fibers and cobalt carbide, and wherein the stator core is greater than or equal to 40% cobalt by weight. A method of forming a stator core, comprising: coating a plurality of carbon fiber sheets with a mixture of resin and cobalt powder, wherein the resin is a phenolic resin, a powdered pitch resin, or a combination comprising at least one of the foregoing; pressing together the plurality of carbon fiber sheets; heat treating the plurality of carbon fiber sheets to form cobalt carbide in the carbon fiber sheets; and forming a plurality of laminations from the resulting mixture to produce the stator core.

### BACKGROUND

Exemplary embodiments pertain to the art of stators for electric machines and, more particularly, to a stator core comprising carbon fibers and cobalt.

Electric machines, such as motors and generators, are commonly found in industrial, commercial, aerospace, and consumer settings. Such machines are employed to drive various kinds of devices, including pumps, conveyors, compressors, fans, and others. In the case of electric motors and generators, these devices generally include a stator, which has a plurality of stator windings, surrounding a rotor.

The stator is often made from laminated heavy metals such as iron. As a result, the heavy weight of the stator can become problematic in weight sensitive contexts, for example, electric motors for aircraft and other mobile equipment. It is therefore important that weight reduction alternatives to heavy iron composites be available for formation of the stator. The stator also produces excess heat during operation due to, for example, eddy current losses in the stator. Excess heat can reduce the efficiency of the machine and result in failure. Therefore, it is important that the electric machine can efficiently dissipate excess heat, thereby reducing temperatures, improving efficiency, and increasing durability.

### BRIEF DESCRIPTION

Disclosed is an electric machine, comprising: a rotor; and a stator core radially outward from the rotor, the stator core being stationary relative to the rotor during operation; wherein the stator core comprises: carbon fibers and cobalt carbide, and wherein the stator core is greater than or equal to 40% cobalt by weight.

Also disclosed is a method of forming a stator core such that the stator core comprises carbon fibers and cobalt carbide, and wherein the stator core is greater than or equal to about 40% cobalt by weight, the method comprising: coating a plurality of carbon fiber sheets with a mixture of resin and cobalt powder, wherein the resin is a phenolic resin, a powdered pitch resin, or a combination comprising at least one of the foregoing; pressing together the plurality of carbon fiber sheets; heat treating the plurality of carbon fiber sheets to form cobalt carbide in the carbon fiber sheets; and forming a plurality of laminations from the resulting mixture to produce the stator core.

### BRIEF DESCRIPTION OF THE DRAWINGS

The following descriptions should not be considered limiting in any way. With reference to the accompanying drawing, like elements are numbered alike:

FIG. 1 is a cross-section of an electric machine according to an exemplary embodiment;

FIG. 2 represents a method of forming a stator core and/or a housing according to an exemplary embodiment; and

FIG. 3 represents another method of forming a stator core and/or a housing according to an exemplary embodiment.

### DETAILED DESCRIPTION

A detailed description of one or more embodiments of the disclosed apparatus and method are presented herein by way of exemplification and not limitation with reference to the Figure.

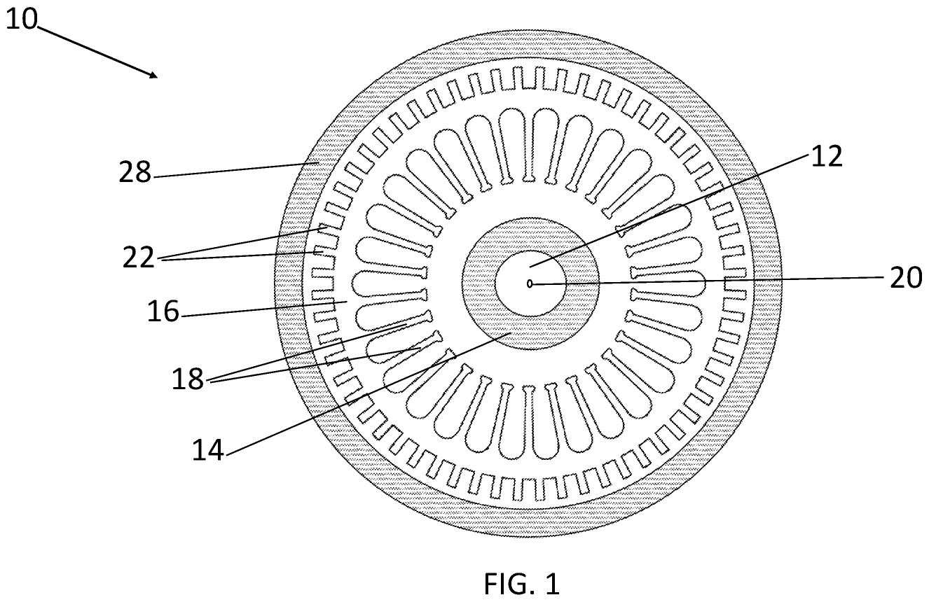

Referring to FIG. 1, an electric machine 10 includes a shaft 12, a rotor 14, a stator core 16, a plurality of mechanical teeth 18, one or more heat fins 22, and a housing 28. The stator core 16 comprises carbon fibers and cobalt carbide. The effect of the carbon fibers either alone or in combination with the inclusion of the cobalt carbide in the stator core 16 is at least one of: to reduce weight and manage thermal/electromagnetic properties of the stator core 16. Similarly, the effect of the carbon fibers either alone or in combination with the inclusion of the cobalt carbide in the stator core 16 is a reduced weight alternative to heavy iron composites available for formation of the stator core 16. In one embodiment, the stator core 16 can be reduced in weight by up to about 30% as compared to heavy iron composite stators. The stator core 16 does not sacrifice thermal/electromagnetic properties as needed for operation of the electric machine 10, for example, magnetic conductance, magnetic saturation/permeability, and high switching frequency. The stator core 16 can also efficiently dissipate heat, thereby reducing temperatures, improving efficiency, and increasing durability.

The electric machine 10 can be a motor or a generator that is able to drive (via mechanical or electrical output) various devices, including pumps, conveyors, compressors, fans, rollers, wheels, or other machines. The electric machine 10 can be a generator or motor of any architecture that has a wound stator including a permanent magnet, synchronous, induction, or switched reluctance. Additionally, all components of the electric machine 10 are not shown, and the electric machine 10 can include other components, such as those particularly suited for the intended use of the electric machine 10.

Shaft 12 extends axially along an axis of rotation (not shown), which is at a radial center 20 of electric machine 10. The shaft 12 is a cylinder with a consistent or varying radius that can be solid, hollow, or multiple pieces fastened together, depending on design considerations. The shaft 12 can be made from a variety of materials, including steel, aluminum, or other materials able to handle high stresses without deformation or failure. When used as a motor, energy can be outputted from the electric machine 10 through the rotation of the shaft 12, which would be used to drive exterior devices. Alternatively, when used as a generator, rotational energy can be inputted into the electric machine 10 by driving the shaft 12 to rotate which, in turn, induces voltage in stator windings (not shown). The induced voltage can be outputted to supply electricity to exterior devices.

The rotor 14 is radially outward from and extends axially along the axis of rotation and the shaft 12. The rotor 14 is fastened or incorporated into the shaft 12 so that the shaft 12 and the rotor 14 rotate in unison. The rotor 14 can be a lamination stack, which is a plurality of cross-sectional pieces (called sheets) fastened together to create a final piece (called the stack) having the dimensions of the rotor 14. The lamination stack of the rotor 14 can be a variety of materials, such as steel or another material, and the sheets can be fastened together through adhesive, resin, or another means, such as welding.

The rotor 14 can include multiple rotor windings, which are not shown in FIG. 1. The rotor windings are wrapped around corresponding winding supports on the rotor 14 and either induce voltage in stator windings or, depending on the configuration of the electric machine 10, stator windings induce voltage in the rotor windings due to the rotation of the rotor windings and the rotor 14 within stator windings.

The stator core 16 extends axially parallel to the axis of rotation and the shaft 12 to be radially outward from the rotor 14. The stator core 16 is physically separate from the rotor 14 so that a gap is present between an outermost surface of the rotor 14 and an innermost surface of the stator core 16. In operation, the stator core 16 is stationary relative to the shaft 12 and the rotor 14, and the shaft 12 and the rotor 14 rotate within the stator core 16 to either induce voltage in stator windings or the rotor windings on the rotor 14 depending on the excitation source. The stator core 16 has a cylindrical shape that extends axially parallel to the axis of rotation. The mechanical teeth 18 are illustrated as multiple inward projections extending from the radially inner surface of the stator core 16 towards the rotor 14. The stator 16 can have a plurality of mechanical teeth 18, including two, four, six, eight, ten, or more teeth 18. The stator windings can be wrapped around the mechanical teeth 18 so that each stator winding is wrapped around one corresponding tooth of the mechanical teeth 18. The stator windings are each continuous wires that are electrically conductive and wrapped multiple times around the mechanical teeth 18. The wires of the stator windings can be arranged in a single layer or can be multiple layers of wires.

During operation of the electric machine 10 as a generator, stator windings can either be energized with electricity to act as an electromagnet to induce voltage in the rotor 14, which is outputted to exterior devices, or the stator windings can be energized by the rotation of the magnetic field from the electrically energized rotor 14 (which creates an electromagnet) or permanent magnets of the rotor 14 so that the voltage induced in the stator windings is outputted to exterior devices.

The heat fins 22 are heat dissipating projections that extend radially outward from an outer surface of the stator core 16 away from the rotor 14. The heat fins 22 allow heat from the stator core 16 to be dissipated radially outward by providing an increased surface area. Additionally, the shape and configuration of the heat fins 22 can be optimized for specific designs, such as reduced weight, minimal diameter increase, manipulation of the flow of cooling fluid, or maximum heat transfer (fluid pressure drop and increased heat transfer are proportional to one another).

The housing 28 has a cylindrical shape centered about the axis of rotation and is radially outward from the stator core 16. The housing 28 provides protection to the electric machine 10 to ensure the inner components (i.e., the shaft 12, the rotor 14, the stator core 16, and the heat fins 22) are not damaged during manufacturing, transportation, installation, and operation, as well as preventing unwanted particulate or fluid from entering the electric machine 10. For example, the housing 28 can provide electromagnetic shielding for the electric machine 10. The housing 28 can be made from a variety of materials, including steel, aluminum, plastic, or another material or combination of materials. The housing 28 can be made from one continuous and monolithic piece or can be a number of pieces fastened together. The housing 28 can include additional features, such as orifices to allow access to the inner components of the electric machine 10 or features that allow attachment of other components to the housing 28.

The stator core 16 and/or the housing 28 can comprise carbon fibers and cobalt carbide, wherein the stator core 16 and/or the housing 28 is greater than or equal to 40% cobalt by weight. For example, the stator core 16 and/or the housing 28 can include about 40% to about 70% cobalt by weight. The stator core 16 and/or the housing 28 can include about 5% to about 30% carbon fibers by weight. The stator core 16 and/or the housing 28 can include carbon fibers within a cobalt/cobalt carbide matrix. The carbon fibers can comprise carbon fiber cloth, graphene, chopped carbon fibers, carbon microfibers, carbon nanofibers, or a combination comprising at least one of the foregoing. The use of carbon fiber reinforcement can result in improved radial magnetic conductance and improved radial heat dissipation properties. The carbon fibers can have a laminar orientation (i.e., parallel layers of carbon fibers) or a random orientation within the stator core 16 and/or the housing 28. Laminar orientation of the carbon fibers can result in improved directional magnetic properties, for example, radial magnetic conductance along the direction of the fibers. Laminar orientation of the carbon fibers can also result in improved directional thermal properties, for example, radial heat dissipation along the direction of the fibers. The stator core 16 and/or the housing 28 can include about 0.01% to about 5% cobalt carbide by weight. The cobalt carbide may be nanoscale cobalt carbide, for example, an average molecular diameter of the cobalt carbide can be less than or equal to about 100 nanometers. The stator core 16 and/or the housing 28 can include less than or equal to about 1% iron, for example, the cobalt composite material can include 0% iron.

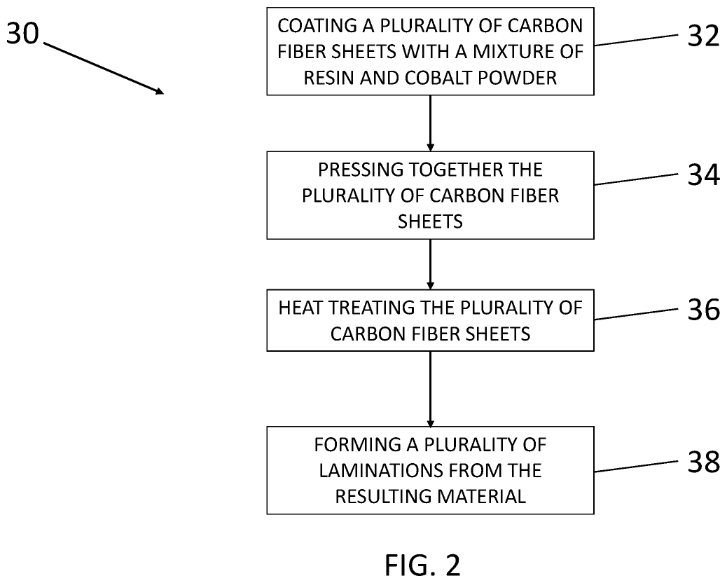

Referring to FIG. 2, a method 30 of forming the stator core 16 and/or the housing 28 is illustrated. The method includes, as indicated at block 32, coating a plurality of carbon fiber sheets with a mixture of resin and cobalt powder. For example, the mixture can comprise less than or equal to about 25% resin, for example, less than or equal to about 10% resin, for example, less than or equal to about 5% resin. The resin can be in liquid or powdered form. For example, the resin can be a phenolic resin, a powdered pitch resin, or a combination comprising at least one of the foregoing. For example, the phenolic resin can carbonize in an inert atmosphere at about 800° C. to about 1200° C., for example, about 1000° C. The resin can further include carbon fibers, for example, chopped carbon fibers, carbon microfibers, carbon nanofibers, or a combination comprising at least one of the foregoing. The resin can act as a binder within the mixture. The plurality of carbon fiber sheets to be coated can comprise carbon fiber cloth, graphene, or a combination comprising at least one of the foregoing. The use of pressed carbon fiber sheets can result in a laminar orientation of the carbon fibers contained therein. The use of powdered pitch resin can result in a more crystalized cobalt/cobalt carbide matrix. At block 34, the plurality of carbon fiber sheets are pressed together. At block 36, the pressed carbon fiber sheets are heat treated. Heat treatment of the carbon fiber sheets can induce formation of nanoscale cobalt carbide in the carbon fiber sheets. At block 38, a plurality of laminations are formed from the resulting material to produce the stator core 16 and/or the housing 28. Like the rotor 14, the stator core 16 and/or the housing 28 can be a lamination stack with a plurality of lamination sheets fastened together to create stator core 16 and/or the housing 28.

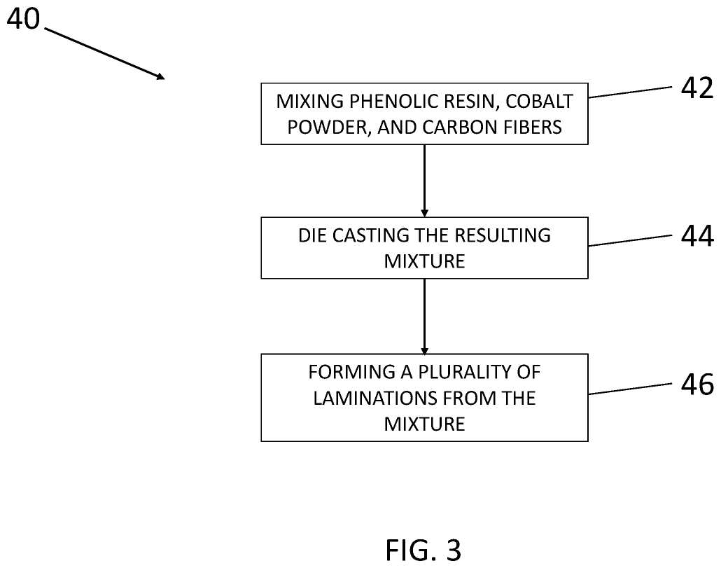

Referring to FIG. 3, a method 40 of forming the stator core 16 and/or the housing 28 is illustrated. The method includes, at block 42, mixing phenolic resin, cobalt powder, and carbon fibers together. The mixture can then be die cast as indicated at block 44. At block 46, a plurality of laminations are formed from the mixture to produce the stator core 16 and/or the housing 28. The die casting method can result in a random orientation of the carbon fibers within the cobalt composite material.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An electric machine, comprising:
a rotor; and
a stator core radially outward from the rotor, the stator core being stationary relative to the rotor during operation;
wherein the stator core comprises: carbon fibers and cobalt carbide, and
wherein the stator core is greater than or equal to 40% cobalt by weight.

2. The electric machine of claim 1, wherein the electric machine is an electric motor or an electric generator.

3. The electric machine of claim 1, wherein the stator core comprises a plurality of laminations.

4. The electric machine of claim 1, wherein the stator core comprises a plurality of mechanical teeth extending radially inward toward the rotor.

5. The electric machine of claim 1, wherein the stator core comprises a plurality of heat fins extending radially outward and away from the rotor.

6. The electric machine of claim 1, further comprising a housing radially outward from the stator core.

7. The electric machine of claim 6, wherein the housing provides electromagnetic shielding for the electric machine.

8. The electric machine of claim 6, wherein the housing comprises: carbon fibers and cobalt carbide, and wherein the housing is greater than or equal to about 40% cobalt by weight.

9. The electric machine of claim 1, wherein the stator core comprises less than or equal to about 1% iron by weight.

10. The electric machine of claim 1, wherein the stator core comprises 0% iron by weight.

11. The electric machine of claim 1, wherein the carbon fibers comprise carbon fiber cloth, graphene, chopped carbon fibers, carbon microfibers, carbon nanofibers, or a combination comprising at least one of the foregoing.

12. The electric machine of claim 1, wherein the carbon fibers have a laminar orientation.

13. The electric machine of claim 1, wherein the carbon fibers have a random orientation.

14. The electric machine of claim 1, wherein the stator core comprises carbon fibers within a cobalt/cobalt carbide matrix.

15. The electric machine of claim 1, the stator core comprises about 40% to about 70% cobalt by weight.

16. The electric machine of claim 1, wherein the stator core comprises about 5% to about 30% carbon fibers by weight.

17. The electric machine of claim 1, wherein the stator core comprises about 0.01% to about 5% cobalt carbide by weight.

18. The electric machine of claim 1, wherein an average molecular diameter of the cobalt carbide is less than or equal to about 100 nanometers.

19. A method of forming a stator core such that the stator core comprises carbon fibers and cobalt carbide, and wherein the stator core is greater than or equal to about 40% cobalt by weight, the method comprising:
coating a plurality of carbon fiber sheets with a mixture of resin and cobalt powder, wherein the resin is a phenolic resin, a powdered pitch resin, or a combination comprising at least one of the foregoing;
pressing together the plurality of carbon fiber sheets;
heat treating the plurality of carbon fiber sheets to form cobalt carbide in the carbon fiber sheets; and
forming a plurality of laminations from the resulting material to produce the stator core.

20. A method of forming a stator core such that the stator core comprises carbon fibers and cobalt carbide, and wherein the stator core is greater than or equal to about 40% cobalt by weight, the method comprising:
mixing phenolic resin, cobalt powder, and carbon fibers;
die casting the resulting mixture; and
forming a plurality of laminations from the mixture to produce the stator core.
